(19) United States
(12) Patent Application Publication
(10) Pub. No.: US 2021/0035118 A1
(43) Pub. Date: Feb. 4, 2021

(54) INTEGRATED INTERACTION SECURITY SYSTEM

(71) Applicant: BANK OF AMERICA CORPORATION, Charlotte, NC (US)

(72) Inventors: Joseph Benjamin Castinado, North Glenn, CO (US); Eric A. Moore, Louisville, KY (US)

(73) Assignee: BANK OF AMERICA CORPORATION, Charlotte, NC (US)

(21) Appl. No.: 16/927,524

(22) Filed: Jul. 13, 2020

Related U.S. Application Data
(60) Provisional application No. 62/880,171, filed on Jul. 30, 2019.

(51) Int. Cl. G06Q 30/00

(52) U.S. Cl. CPC G06Q 30/018

(57) ABSTRACT

An integrated interaction security system that is utilized not only to view traditional activity that may suggest potential misappropriation within an interaction between entities, but also to analyze the resource pools and/or interactions thereof that are unrelated to the interaction and resource pools that resulted in the identification of potential misappropriation. As such, the integrated interaction security system may be used to identify if misappropriation actually occurred and/or in order to identify the misappropriator in the interaction.

### CROSS REFERENCE AND PRIORITY CLAIM UNDER 35 U. S.C. § 119

The present Application for a Patent claims priority to U.S. Provisional Patent Application Ser. No. 62/880,171 entitled “Integrated Interaction Security System,” which was filed on Jul. 30, 2019 and assigned to the assignees hereof, and is hereby expressly incorporated by reference herein.

### FIELD

The present invention relates to a security system, and more particularly an integrated security system that allows for the determination and identification of a misappropriator involved in interactions between entities.

### BACKGROUND

Organizations typically do not have insight to the interactions of each of the entities involved in an interaction, and as such, when an interaction is identified as involving potential misappropriation it is difficult to identify the entity that is likely the cause of the potential misappropriation.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer implemented methods, and computer program products are described herein for an integrated interaction security system that is utilized not only to view traditional activity that may suggest potential misappropriation within an interaction between entities, but also to analyze the resource pools and/or interactions thereof that are unrelated to the interaction and resource pools that resulted in the identification of potential misappropriation. As such, the integrated interaction security system may be used to identify if misappropriation actually occurred and/or in order to identify the misappropriator in the interaction.

Embodiments of the invention comprise systems, computer implemented methods, and/or computer program products for a security system for identifying misappropriators. The invention comprises identifying an interaction that includes potential misappropriation, and identifying a first entity and a first entity resource pool and a second entity and a second entity resource pool for the interaction. The invention further comprises accessing one or more additional first entity resource pools of the first entity and one or more additional second entity resource pools of the second entity. The invention also comprises identifying unrelated first entity interactions of the first entity using the one or more additional first entity resource pools, and identifying unrelated second entity interactions of the second entity using the one or more additional second entity resource pools. The invention also comprises determining that the first entity, the second entity, or an affiliated entity is a misappropriator, and taking a security action with respect to the misappropriator.

In further accord with embodiments, the invention further comprises identifying one or more affiliated entity pools of one or more affiliated entities affiliated with the first entity or the second entity, and identifying unrelated affiliated entity interactions of the one or more affiliated entities. Moreover, determining that the first entity, the second entity, or the affiliated entity is the misappropriator is further based on the unrelated affiliated entity interactions of the one or more affiliated entities.

In other embodiments of the invention, the affiliated entity is the misappropriator and the security action is taken on the affiliated entity.

In still other embodiments of the invention, the security action comprises preventing resource transfers to or from an affiliated entity resource pool of the affiliated entity.

In yet other embodiments of the invention, the first entity or the second entity are identified as the misappropriator.

In other embodiments of the invention, the security action is preventing the interaction.

In further accord with embodiments of the invention, the security action is preventing additional interactions by the misappropriator.

In other embodiments of the invention, the security action is preventing resource transfers to or from the first entity resource pool, the second entity resource pool, the one or more additional first entity resource pools, or the one or more additional second entity resource pools.

In still other embodiments, the invention further comprises identifying the misappropriator comprises identifying the second entity receives resources in the second entity resource pool and the resources are transferred out of the second entity resource pool within a time period.

In yet other embodiments, the invention further comprises identifying the misappropriator comprises receiving a report of a plurality of misappropriated resource pools, and comparing the first entity resource pool, the second entity resource pool, or the one or more affiliated entity resource pools with the plurality of misappropriated resource pools.

In other embodiments, the invention further comprises identifying the misappropriator comprises receiving a report of a plurality of misappropriated resource pools, and comparing the one or more additional first entity resource pools of the first entity, the one or more additional second entity resource pools of the second entity, and the one or more affiliated entity pools with the plurality of misappropriated resource pools from the report.

In further accord with embodiments, the invention further comprises identifying one or more first entity interactions using the first entity resource pool, and the determination that the first entity is the misappropriator is further based on the one or more first entity interactions using the first entity resource pool.

In other embodiments, the invention further comprises identifying one or more second entity interactions using the second entity resource pool, and the determination that the second entity is the misappropriator is further based on the one or more second entity interactions using the second entity resource pool.

In still other embodiments of the invention, identifying the unrelated first entity interactions of the first entity using the one or more additional first entity resource pools, or identifying the unrelated second entity interactions of the second entity using the one or more additional second entity resource pools, comprises receiving the unrelated first entity interactions or the unrelated second entity interactions from two or more organizations within a consortium of organization sharing misappropriated interaction information.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, and wherein:

FIG. 1 illustrates a block system diagram of a cross-referenced entity security system environment, in accordance with some embodiments of the present disclosure.

FIG. 2 illustrates a process flow for identifying a misappropriator when an interaction has been flagged as involving potential misappropriation, in accordance with some embodiments of the present disclosure.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Systems, methods, and computer program products are described herein for an integrated interaction security system that is utilized not only to view traditional activity that may suggest potential misappropriation within an interaction between entities, but also to analyze the resource pools and/or interactions thereof that are unrelated to the interaction and resource pools that resulted in the identification of potential misappropriation. As such, the integrated interaction security system may be used to identify if misappropriation actually occurred and/or in order to identify the misappropriator in the interaction, as will be discussed in further detail herein.

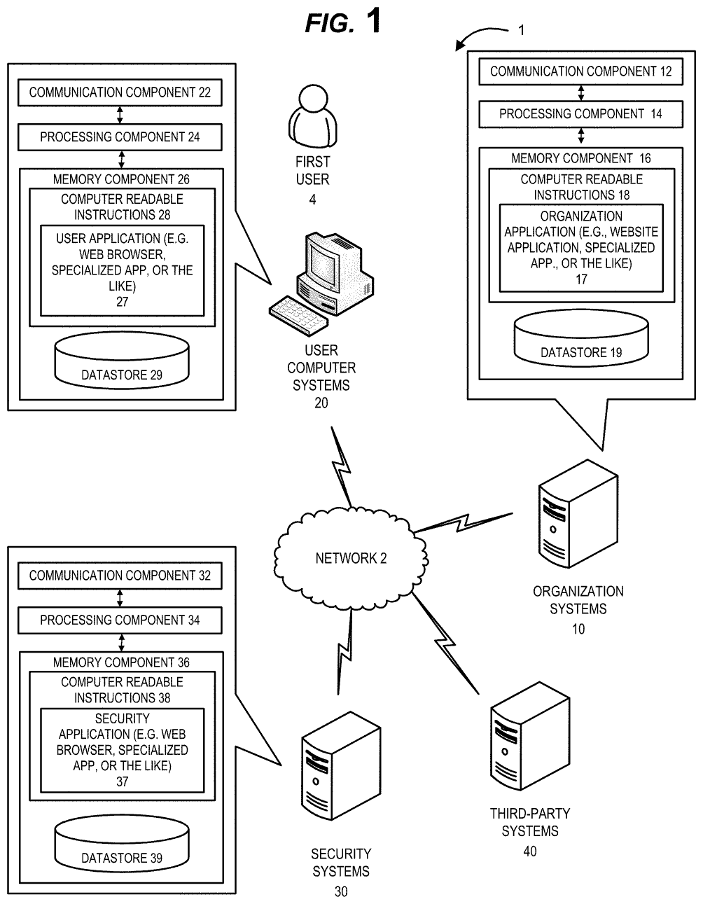

FIG. 1 illustrates an integrated interaction security system 1, in accordance with embodiments of the invention. As illustrated in FIG. 1, one or more organization systems 10 are operatively coupled, via a network 2, to one or more user computer systems 20, one or more security systems 30, one or more third-party systems 40, and/or one or more other systems (not illustrated). In this way, the security system 30 may be utilized to identify interactions that may include misappropriation and/or identifying a misappropriator after an interaction has been identified as potentially involving misappropriation. As will be described herein, the security systems 30 may be utilized not only to view traditional activity that may suggest potential misappropriation, but also in order to determine the users' resource pools, the merchants' resource pools, and in particular, the flow of resources between the resource pools of the users and/or the merchants that may or may not be related to the interaction. It should be understood that the interactions may occur between users, between merchants, and/or between a user and a merchant.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1, the one or more organization systems 10 generally comprise one or more communication components 12, one or more processing components 14, and one or more memory components 16. The one or more processing components 14 are operatively coupled to the one or more communication components 12 and the one or more memory components 16.

As used herein, the term “processing component” (otherwise described as a “processor,” “processing device,” or the like) generally includes circuitry used for implementing the communication and/or logic functions of a particular system. For example, a processing component may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components may include functionality to operate one or more software programs based on computer-readable instructions thereof, which may be stored in the one or more memory components.

A processing component may be configured to use a network interface to communicate with one or more other devices on the network 2. In this regard, the network interface may include an antenna operatively coupled to a transmitter and a receiver (together a “transceiver”). The processing component may be configured to provide signals to and receive signals from the transmitter and receiver, respectively. The signals may include signaling information in accordance with the air interface standard of the applicable cellular system of the wireless telephone network that may be part of the network 2. In this regard, the systems may be configured to operate with one or more air interface standards, communication protocols, modulation types, and access types. By way of illustration, the components may be configured to operate in accordance with any of a number of first, second, third, fourth, fifth-generation communication protocols, and/or the like. For example, the computing systems may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, or the like. The components may also be configured to operate in accordance with non-cellular communication mechanisms, such as via a wireless local area network (WLAN) or other communication/data networks.

The network interface may also include an application interface in order to allow an entity (e.g., user, merchant, organization, or the like) to execute some or all of the processing described herein. The application interface may have access to the hardware (e.g., the transceiver, and software previously described with respect to the network interface). Furthermore, the application interface may have the ability to connect to and communicate with an external data storage on a separate system within the network 2.

The communication components may include an interface for a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors, or the like. The communication components may have an interface that includes user output devices and/or input devices. The input and/or output devices may include a display (e.g., a liquid crystal display (LCD) or the like) and a speaker or other audio device, which are operatively coupled to the processing components. The input and/or output devices, which may allow the devices to receive data from or send data to an user, may further include any of a number of devices allowing the devices to receive data from a user, such as a keypad, keyboard, touch-screen, touchpad, microphone, mouse, joystick, other pointer device, button, soft key, and/or other input device(s).

As such, the one or more processing components 14 use the one or more communication components 12 to communicate with the network 2 and other components on the network 2, such as, but not limited to, the components of the one or more user computer systems 20, the one or more security systems 30, the one or more third-party systems 40, and/or the one or more other systems (not illustrated).

As further illustrated in FIG. 1, the one or more organization systems 10 comprise computer-readable instructions 18 stored in the one or more memory components 16, which in some embodiments includes the computer-readable instructions 18 of the one or more organization applications 17 (e.g., secure website application, secure dedicated application, or the like). In some embodiments, the one or more memory components 16 include one or more data stores 19 for storing data related to the one or more organization systems 10, including, but not limited to, data created, accessed, and/or used by the one or more organization applications 17. The organization may be an entity that administers, controls, or has access to the resource pools of the users 4 and the third-parties. It should be understood that the users 4, third-parties, and organizations may all be referred to herein as an entity.

As illustrated in FIG. 1, users 4 may communicate with the third-parties in order to enter into and/or review interactions that have been entered into using resource pools that are held by the organization on behalf of other entities, and the security system 30 may be used to determine misappropriators regardless of whether or not they are involved in the interaction. It should be understood that the user 4 may be a user that is entering into an interaction with the third-party, the user 4 may be a user representing a third-party in an interaction, the user 4 may be a user that acts on behalf of the organization, the user 4 may be a user that acts on behalf of the security system 30. Consequently, the one or more users 4 may be an individual acting on his/her own behalf, and/or the one or more users 4 may be employees, agents, representatives, officers, or the like of any entity.

As such, the user computer systems 20 may communicate with the one or more organization systems 10, the one or more security systems 30, the one or more third-party system 40, and/or other systems (not illustrated). The one or more user computer systems 20 may be a desktop, laptop, tablet, mobile device (e.g., smartphone device, or other mobile device), or any other type of computer that generally comprises one or more communication components 22, one or more processing components 24, and one or more memory components 26.

The one or more processing components 24 are operatively coupled to the one or more communication components 22, and the one or more memory components 26. The one or more processing components 24 use the one or more communication components 22 to communicate with the network 2 and other components on the network 2, such as, but not limited to, the one or more organization systems 10, the one or more security systems 30, the one or more third-party systems 40, and/or the other systems (not illustrated).

As illustrated in FIG. 1, the one or more user computer systems 20 may have computer-readable instructions 28 stored in the one or more memory components 26, which in some embodiments includes the computer-readable instructions 28 for user applications 27, such as dedicated applications (e.g., apps, applet, or the like), portions of dedicated applications, a web browser or other apps that allow access to applications located on other systems, or the like. In some embodiments, the one or more memory components 26 include one or more data stores 29 for storing data related to the one or more user computer systems 20, including, but not limited to, data created, accessed, and/or used by the one or more user computer systems 20. The user application 27 may use the applications of the one or more organization systems 10, the one or more security systems 30, the one or more third-party systems 40, and/or one or more other systems (not illustrated) in order to enter into and/or review interactions that have been entered into using resource pools that are held by the organization, and determine misappropriators regardless of whether or not they are involved in the interaction, as will be described herein.

As illustrated in FIG. 1, one or more security systems 30 may be utilized by the one or more organization systems 10, the one or more user computer systems 20, the one or more third party systems 40, and/or other systems to aid in identifying misappropriators based on identification of an interaction that includes potential misappropriation, and regardless of whether or not the misappropriator is involved in the interaction. That is, the security system 30 may be utilized in order to determine the actual entity (e.g., user, organization, third-party, or the like) that is a misappropriator within an interaction and/or affiliated with the interaction.

As such, the one or more security systems 30 are operatively coupled, via a network 2, to the one or more organization systems 10, the one or more user computer systems 20, the one or more third-party systems 40, and/or the other systems (not illustrated). The one or more security systems 30 generally comprise one or more communication components 32, one or more processing components 34, and one or more memory components 36.

The one or more processing components 34 are operatively coupled to the one or more communication components 32, and the one or more memory components 36. The one or more processing components 34 use the one or more communication components 32 to communicate with the network 2 and other components on the network 2, such as, but not limited to, the components of the one or more organization systems 10, the one or more user computer systems 20, the one or more third-party systems 40, and/or the one or more other systems (not illustrated).

As illustrated in FIG. 1, the one or more security systems 30 may have computer-readable instructions 38 stored in the one or more memory components 36, which in one embodiment includes the computer-readable instructions 38 of one or more security applications 37. In some embodiments, the one or more memory components 36 include one or more data stores 39 for storing data related to the one or more security systems 30, including, but not limited to, data created, accessed, and/or used by the one or more security applications 37. The one or more security applications 37 allow for the identification and analysis of resource pools of the entities (e.g., related and/or unrelated) that may be directly involved in, or unrelated to, the interaction which may include the potential misappropriation.

Moreover, as illustrated in FIG. 1, the one or more third-party systems 40 are operatively coupled to the one or more organization systems 10, the one or more user computer systems 20, the one or more security systems 30, and/or the one or more other systems, through the network 2. The one or more third-party systems 40, and/or other like systems have components the same as or similar to the components described with respect to the one or more organization systems 10, the one or more user computer systems 20, and/or the one or more security systems 30 (e.g., one or more communication components, one or more processing components, and one or more memory devices with computer-readable instructions of one or more third-party applications, one or more datastores, or the like). Thus, the one or more third-party systems 40 communicate with the one or more organization systems 10, the one or more user computer systems 20, the one or more security systems 30, and/or each other in same or similar way as previously described with respect to the one or more organization systems 10, the one or more user computer systems 20, and/or the one or more security systems 30. The one or more third-party systems 40 may comprises the systems and applications which a third-party uses to enter into interactions with another entity, such as another user 4 and/or another entity.

The one or more other systems (not illustrated) may include the systems, and components thereof, for allowing communications between the systems (e.g., intermediaries that act as gateways, application programing interfaces (APIs), or the like to allow communication between the systems).

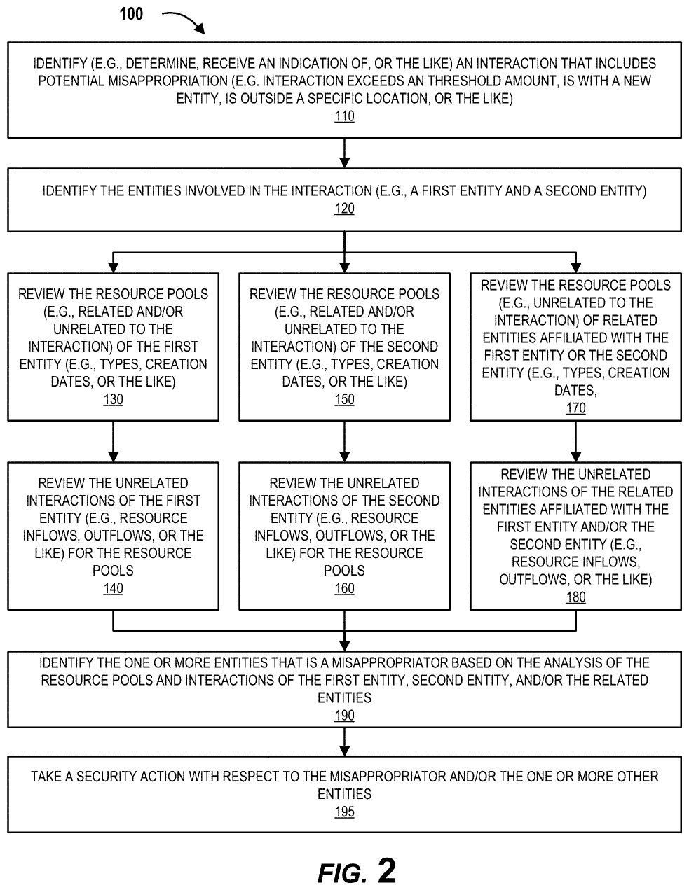

FIG. 2 illustrates a process flow for identifying misappropriators utilizing the integrated interaction security system 1. Block 110 of FIG. 2 illustrates that the system identifies an interaction that includes potential misappropriation. It may be that the systems (e.g., security system 30, or the like) make the determination based on the information available to the system. For example, the system may perform its own analysis related to an interaction and make a determination as to whether or not an interaction potentially involved misappropriation (e.g., is not authorized, or the like). This may include determining that an interaction involved an entity that is not located in the location at which the interaction occurred, that the interaction was entered into with another entity in which the entity may not have previously interacted, the interaction resource amount of the interaction is greater than typical interaction resource amounts, the interaction occurred during a time when any entity is typically not available, multiple interactions have occurred during a time period, and/or other information that may indicate that potential misappropriation may have occurred. These and other types of interactions are what are traditionally used in order to determine if potential misappropriation has occurred.

Alternatively, the system may receive a misappropriation notification from another entity and/or entity system that potential misappropriation has occurred. In some examples, the system may receive a notification from a user 4 (e.g., customer) that an interaction entered into with the user's resource pool (e.g., debit card, credit card, or other like card tied to a particular resource pool, such as a checking account, savings account, equity line, prepaid account, or the like) was not authorized by the user 4. For example, the user 4 may indicate that a misappropriator, other entity, or the like entered into an interaction without the permission of the user 4, or the like. Alternatively, the misappropriation notification may include receiving a notification from an organization and/or third-party that an interaction may include potential misappropriation.

It should be understood that the misappropriation notification may include an e-mail, call, message over the Internet, or any other like communication from an entity indicating an interaction may include misappropriation. In still other examples, the security system 30 may receive a list of resource pools that may have been potentially misappropriated, and as such, any interactions in which the resource pools may be used may be subject to further analysis. It should be further understood that while the interactions have been described generally as a user entering into an interaction with a merchant, the interactions may include the user 4 and/or the third party (e.g., merchant) transferring funds within accounts (e.g., between account purported to be owned by the same entity).

It should be understood that potential misappropriation may include identifying that the entirety, or a portion, of the interaction was performed without authorization (e.g., a first entity and/or a second entity were not authorized to enter into the interaction). For example, the first entity and/or the second entity are not who they say they are, are using a resource pool that does not belong to them (e.g., the resource pools has been reported as being used without authorization, or the like), the resource amount for the interaction was altered, the resource pool from which the resources are received and/or to which the resources are sent was altered, or other like misappropriation.

Block 120 of FIG. 2 illustrates that the security system 30 may identify the entities involved in the interaction (e.g., a first entity and/or a second entity). For example, the interaction may occur between a first entity (e.g., a user 4, or the like) that is a customer of a second entity (e.g., a merchant, or the like). Alternatively, the first entity may be a merchant or user that is transferring resources from a first entity resource pool to a second entity resource pool owned by the first entity (e.g., from a deposit account to another account, or the like). In other embodiments, the first entity may be merchant that is a customer of a second entity that is also a merchant. As such, the interaction may be any type of interaction between two entities, or between resource pools of the same entity.

As further illustrated in block 130 of FIG. 2, the security system 30 may be used to review the resource pools of the first entity. For example, the resource pools of the first user may include a user's credit cards, deposit accounts (e.g., checking account, savings accounts), investment accounts, equity lines, and/or other like accounts. In particular, should the first entity have multiple resource pools with the same organization (or should multiple organizations share information with each other in a consortium), the security system 30 (e.g., as operated by the organization, or the like) is able to review the incoming and/or outgoing resource transfers with respect to all of the resource pools of the first entity, including the resource pools that are unrelated to a particular interaction, as well as the resource pool used with the particular interaction being investigated. In some embodiments, the resource pools are analyzed in order to determine the type of resource pools of the first entity, the dates the resource pools were opened (e.g., opened within days, weeks, months, over a year, or the like), how often the resource pools are utilized, are resource pools closed after a certain time, or the like.

Block 140 of FIG. 2 further illustrates that the security system 30 may be used to review the interactions within the resource pools of the of the first entity. For example, the security system 30 may review unrelated interactions (e.g., unrelated to the interaction that may include potential misappropriation, or the like) that the first entity made with other entities and/or between its own resource pools. For example, the inflows and outflows of the resources between the resource pools may be analyzed (e.g., how often resources are transferred, where the resources are transferred, amounts of the resources, day and time of transfers, how quickly resources are moved out of the resource pools, the average balances in the resource pools, or the like). The analysis of the interactions may be utilized in order to determine if the first entity or the second entity is the likely misappropriator, as will be discussed in further detail with respect to block 190.

As further illustrated in block 150 of FIG. 2, the security system 30 may be used to review the resource pools of the second entity. For example, the resource pools of the second entity may include a merchant's credit accounts (e.g., loan accounts, or the like), deposit accounts (e.g., operating accounts, or the like) and/or other like accounts. In particular, should the second entity have multiple resource pools with the same organization (or should multiple organizations share information with each other in a consortium) and/or with the same organization at which the first entity has resource pools, then the security system 30 (e.g., as operated by the organization, or the like) is able to review the incoming and/or outgoing resource transfers with respect to the resource pools of the second entity in addition to the first entity. In some embodiments, the resource pools are analyzed in order to determine the type of resource pools of the first entity, the dates the resource pools were opened (e.g., opened within days, weeks, months, over a year, or the like), how often the resource pools are utilized, are resource pools closed after a certain time, or the like.

Blocks 130 and 150 are described as the first entity being a customer of the second entity, which is a merchant. However, it should be understood that both entities may be users (e.g., individual users acting on their own behalf), or both entities may be merchants and the interaction may include an interaction between merchants (e.g., through entity systems, through a representative user, or the like).

Block 160 of FIG. 2 further illustrates that the security system 30 may be used to review the interactions within the resource pools of the of the second entity. For example, the security system 30 may review unrelated interactions (e.g., unrelated to the interaction that may include potential misappropriation, or the like) that the second entity made with other entities and/or between its own resource pools. For example, as previously discussed, the inflows and outflows of the resources between the resource pools may be analyzed (e.g., how often resources are transferred, where the resources are transferred, amounts of the resources, day and time of transfers, how quickly resources are moved out of the resource pools, the average balances in the resource pools, or the like). The analysis of the interactions may be utilized in order to determine if the first entity or the second entity is the likely misappropriator, as will be discussed in further detail with respect to block 190.

It should be understood that while it is discussed that the multiple resource pools of the first entity and the second entity that are located with the same organization may be analyzed, it should be understood that some of the resource pools may be located with a separate organization; however, the organizations may share information related to resources, resource pools, and/or interactions (e.g., should the entity allow sharing of such information, or the like).

Block 170 of FIG. 2 further illustrates that the security system 30 may be used to review the resource pools of affiliated entities. For example, the resource pools of the first entity (e.g., user, merchant, or the like) and/or a second entity (e.g., user, merchant, or the like) may include interactions with affiliated entities (e.g., other users, merchants, organizations, or the like) that were not a part of the original interaction being investigated, but were involved in separate interactions with the first entity or the second entity. In some embodiments, the resource pools are analyzed in order to determine the type of resource pools of the first entity, the dates the resource pools were opened (e.g., opened within days, weeks, months, over a year, or the like), when related resource pools were closed, how often the resource pools are utilized, or the like.

Block 180 of FIG. 2 further illustrates that the security system 30 may review the interactions within the resource pools of the of the affiliate entities. For example, the security system 30 may review unrelated interactions (e.g., unrelated to the interaction that may include the potential misappropriation, or the like) that the affiliated entities made with other entities and/or between their own resource pools. For example, as previously discussed, the inflows and outflows of the resources between the resource pools may be analyzed (e.g., how often resources are transferred, where the resources are transferred, amounts of the resources, day and time of transfers, how quickly resources are moved out of the resource pools, the average balances in the resource pools, or the like). The analysis of the interactions may be utilized in order to determine if the first entity or the second entity is the likely misappropriator, as will be discussed in further detail with respect to block 190.

Block 190 of FIG. 2 illustrates that the one or more resource pools and/or the interactions thereof of the first entity and the second entity involved in the interaction that includes potential misappropriation are analyzed, as well as the one or more resource pools and/or the interactions thereof of the affiliated entities of the first entity and/or the second entity.

Various examples will be presented in order to illustrate how the security system 30 may identify if misappropriation occurred and/or the identity of the misappropriator. However, it should be understood that these examples are merely illustrative and do not illustrate all of the ways that the potential misappropriation may be verified and/or the misappropriator may be identified.

In some embodiments, the organization may receive a report of all of the potential resource pools (e.g., credit card, debit card, or other like account(s)) that have been potentially misappropriated. The report may be based on a plurality of organizations sharing misappropriation information with each other. As such, when interactions have been identified as being potentially misappropriated (e.g., as described with respect to block 110) any of the entities could be the misappropriator. For example, when an interaction is entered into, the interaction may be a legitimate interaction (e.g., an entity is using a resource pool without knowing that the resource pool may have been misappropriated); the interaction may be a first entity (e.g., a misappropriator) using a resource pool (e.g., card, or the like) at a legitimate second entity (e.g., legitimate merchant, or the like); the interaction may be a first entity (e.g., a misappropriator) entering an interaction with an non-legitimate second entity (e.g., the misappropriator is acting on its own by setting up a non-legitimate second entity with which to enter into non-legitimate interactions); the interaction may be a second entity (e.g., misappropriator) entering an interaction with a non-legitimate first entity (e.g., the merchant is acting on its own by using misappropriated resource pools of a first entity), or the like.

In some embodiments, it may be clear that the first entity and/or the second entity is not a misappropriator. For example, the second entity is a large entity that has a national presence, and not a small entity that has a single location or less than two, three, four, five, seven, ten, and/or the like number of locations, or only has an Internet presence, which may make it more likely that the second entity could be a non-legitimate entity. As such, in situations where the second entity is a large merchant that is known by the organization (e.g., merchant is on a list of known legitimate merchants, or the like) the analysis of the second entity resources pools and/or interactions thereof may be bypassed. As such, in these instances the security system 30 may identify the first entity as the misappropriator automatically.

In other examples, the resource pools of the second entity (e.g., merchant) may be reviewed, and it may be identified that when the second entity receives a resource transfer from the first entity (e.g., a user), and the funds are deposited into a deposit resource pool of the second entity, the resources are transferred out of the deposit account within a threshold time period (e.g., within 1, 2, 4, 6, 8, 10, 12, 18, 24, hours, days, or the like). In this way, the second entity (e.g., merchant) may be identified as the misappropriator since almost immediately after receipt of the resources in a deposit resource pool, the resources are removed, and this provides an indication that the second entity is likely the misappropriator. Typical accounts of merchants do not remove resources quickly and typically keep a higher balance in a deposit resource pool in order to allow for the transfer of resources for operations. Keeping a low balance in the resource pool and/or quickly removing funds when they are deposited may indicate that the second entity is a misappropriator because the second entity likely does not want resources in the resource pool should the second entity be identified as a misappropriator (e.g., which may result in freezing of the resources in the resource pool).

In other examples, when a potential misappropriated interaction is identified, the security system 30 may identify that multiple known misappropriated resource pools (e.g., multiple known credit cards, or the like) have been used at the same second entity within a period of time, the second entity may be identified as the likely misappropriator. However, should only one misappropriated resource pool be used at the second entity, this may indicate that the first entity is the misappropriator.

With respect to identifying the identity of the misappropriator, the security system 30 may review the resource pools of the first entity and/or the second entity to which the resources are eventually being sent (e.g., the resource flows into and/or out of the resource pools that were used in the interaction being investigated, and/or the unrelated resource pools of the first entity, second entity, and/or the affiliated entities). As such, the entity that is the real misappropriator may not be the entity related to the resource pool (e.g., dummy resource pool) used in the interaction that includes misappropriation, but the ultimate resource pool to which the resources are sent. As such, having access to interactions with affiliated entities may indicate that the affiliated entity is the actual misappropriator.

Block 195 of FIG. 2 illustrates that the security system 30 may take a security action with respect to the one or more interactions and/or the one or more resource pools of the first entity, second entity, and/or affiliated entities that have been identified as a misappropriator. For example, the security system 30 may prevent the interaction that may include potential misappropriation. In other examples, the security system 30 may prevent all additional interactions from one or more resource pools of a first entity, a second entity, and/or affiliated entities. By the organization having insight into the resource pools and interactions of the first entity, second entity, and/or affiliated entities (e.g., resource pools all being supported by the organization), the organization may not be able to prevent the first misappropriated interaction, but the organization may be able to prevent additional misappropriated interactions of which the organization would not otherwise have been aware. It should be understood that the organization may prevent additional interactions to occur with respect to the resource pools of the misappropriator and/or may prevent other entities from interacting with the resource pools of the misappropriator. However, if the organization does not have control over a particular resource pool, the organization may send a misappropriation notification to another organization in order to alert another organization of the potential misappropriation.

The disclosure of the present invention provides improvements over traditional security system because it not only reviews the interaction taking place between two entities, but also the other related and unrelated interactions of the entities, the related and unrelated resource pools the entities, and/or the related and unrelated and related interactions and resource pools of any affiliated entities. In this way, the security system described herein is able to more accurately determine the actual misappropriator involved in an interaction, and aid in preventing additional interactions that involve the misappropriator. Further, by two more organizations (e.g., in a centralized consortium, or the like) sharing information about potential misappropriators and/or misappropriated interactions, the present disclosure allows organizations to capture and share information about potential misappropriated interactions, resource pools, and/or entities.

It should be understood that the systems described herein may be configured to establish a communication link (e.g., electronic link, or the like) with each other in order to accomplish the steps of the processes described herein. The link may be an internal link within the same entity (e.g., within the same financial institution) or a link with the other entity systems. In some embodiments, the one or more systems may be configured for selectively monitoring the resource usage and availability. These feeds of resource usage and availability may be provided via wireless network path portions through the Internet. When the systems are not providing data, transforming data, transmitting the data, and/or creating the reports, the systems need not be transmitting data over the Internet, although it could be. The systems and associated data for each of the systems may be made continuously available, however, continuously available does not necessarily mean that the systems actually continuously generate data, but that systems are continuously available to perform actions associated with the systems in real-time (i.e., within a few seconds, or the like) of receiving a request for it. In any case, the systems are continuously available to perform actions with respect to the data, in some cases in digitized data in Internet Protocol (IP) packet format. In response to continuously monitoring the real-time data feeds from the various systems, the systems may be configured to update activities associated with the systems, as described herein.

Moreover, it should be understood that the process flows described herein include transforming the data from the different systems (e.g., internally or externally) from the data format of the various systems to a data format associated with the reports for display. There are many ways in which data is converted within the computer environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

As will be appreciated by one of skill in the art in view of this disclosure, embodiments of the invention may be embodied as an apparatus (e.g., a system, computer program product, and/or other device), a method, or a combination of the foregoing. Accordingly, embodiments of the invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the invention may take the form of a computer program product comprising a computer-usable storage medium having computer-usable program code/computer-readable instructions embodied in the medium (e.g., a non-transitory medium, or the like).

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Python, Smalltalk, C++ or the like. However, the computer program code/computer-readable instructions for carrying out operations of the invention may also be written in conventional procedural programming languages, such as the “C” programming language or similar programming languages.

Embodiments of the invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A security system for identifying misappropriators, the system comprising:
one or more memory devices having computer readable code stored thereon; and
one or more processing devices operatively coupled to the one or more memory devices, wherein the one or more processing devices are configured to execute the computer readable code to:
identify an interaction that includes potential misappropriation;
identify a first entity and a first entity resource pool and a second entity and a second entity resource pool for the interaction;
access one or more additional first entity resource pools of the first entity and one or more additional second entity resource pools of the second entity;
identify unrelated first entity interactions of the first entity using the one or more additional first entity resource pools;
identify unrelated second entity interactions of the second entity using the one or more additional second entity resource pools;
determine that the first entity, the second entity, or an affiliated entity is a misappropriator; and
take a security action with respect to the misappropriator.

2. The system of claim 1, wherein the one or more processing devices are further configured to execute the computer readable code to:
identify one or more affiliated entity pools of one or more affiliated entities affiliated with the first entity or the second entity; and
identify unrelated affiliated entity interactions of the one or more affiliated entities;
wherein determining that the first entity, the second entity, or the affiliated entity is the misappropriator is further based on the unrelated affiliated entity interactions of the one or more affiliated entities.

3. The system of claim 2, wherein the affiliated entity is the misappropriator and the security action is taken on the affiliated entity.

4. The system of claim 3, wherein the security action comprises preventing resource transfers to or from an affiliated entity resource pool of the affiliated entity.

5. The system of claim 1, wherein the first entity or the second entity are identified as the misappropriator.

6. The system of claim 1, wherein the security action is preventing the interaction.

7. The system of claim 1, wherein the security action is preventing additional interactions by the misappropriator.

8. The system of claim 1, wherein the security action is preventing resource transfers to or from the first entity resource pool, the second entity resource pool, the one or more additional first entity resource pools, or the one or more additional second entity resource pools.

9. The system of claim 1, wherein identifying the misappropriator comprises identifying the second entity receives resources in the second entity resource pool and the resources are transferred out of the second entity resource pool within a time period.

10. The system of claim 2, wherein identifying the misappropriator comprises:
receiving a report of a plurality of misappropriated resource pools; and
comparing the first entity resource pool, the second entity resource pool, or the one or more affiliated entity resource pools with the plurality of misappropriated resource pools.

11. The system of claim 2, wherein identifying the misappropriator comprises:
receiving a report of a plurality of misappropriated resource pools; and
comparing the one or more additional first entity resource pools of the first entity, the one or more additional second entity resource pools of the second entity, and the one or more affiliated entity pools with the plurality of misappropriated resource pools from the report.

12. The system of claim 1, wherein the one or more processing devices are further configured to execute the computer readable code to:
identify one or more first entity interactions using the first entity resource pool; and
wherein determining that the first entity is the misappropriator is further based on the one or more first entity interactions using the first entity resource pool.

13. The system of claim 1, wherein the one or more processing devices are further configured to execute the computer readable code to:
identifying one or more second entity interactions using the second entity resource pool; and
wherein determining that the second entity is the misappropriator is further based on the one or more second entity interactions using the second entity resource pool.

14. The system of claim 1, wherein identifying the unrelated first entity interactions of the first entity using the one or more additional first entity resource pools or identifying the unrelated second entity interactions of the second entity using the one or more additional second entity resource pools, comprises receiving the unrelated first entity interactions or the unrelated second entity interactions from two or more organizations within a consortium of organization sharing misappropriated interaction information.

15. A computer implemented method for identifying misappropriators, the method comprising:
identifying, by one or more processing components, an interaction that includes potential misappropriation;
identifying, by the one or more processing components, a first entity and a first entity resource pool and a second entity and a second entity resource pool for the interaction;
accessing, by the one or more processing components, one or more additional first entity resource pools of the first entity and one or more additional second entity resource pools of the second entity;
identifying, by the one or more processing components, unrelated first entity interactions of the first entity using the one or more additional first entity resource pools;
identifying, by the one or more processing components, unrelated second entity interactions of the second entity using the one or more additional second entity resource pools;
determining, by the one or more processing components, that the first entity, the second entity, or an affiliated entity is a misappropriator; and
taking, by the one or more processing components, a security action with respect to the misappropriator.

16. The computer implemented method of claim 15, the method further comprising:
identifying, by the one or more processing components, one or more affiliated entity pools of one or more affiliated entities affiliated with the first entity or the second entity; and
identifying, by the one or more processing components, unrelated affiliated entity interactions of the one or more affiliated entities;
wherein determining that the first entity, the second entity, or the affiliated entity is the misappropriator is further based on the unrelated affiliated entity interactions of the one or more affiliated entities.

17. The computer implemented method of claim 16, wherein the security action is preventing resource transfers to or from the first entity resource pool, the second entity resource pool, the one or more additional first entity resource pools, or the one or more additional second entity resource pools of the second entity.

18. The computer implemented method of claim 16, wherein identifying the misappropriator comprises identifying the second entity receives resources in the second entity resource pool and the resources are transferred out of the second entity resource pool within a time period.

19. The system of claim 1, wherein the one or more processing devices are further configured to execute the computer readable code to:
identify one or more first entity interactions using the first entity resource pool or one or more second entity interactions using the second entity resource pool; and
wherein determining that the first entity, the second entity, or the affiliated entity is the misappropriator is further based on the one or more first entity interactions using the first entity resource pool or the one or more second entity interactions using the second entity resource pool.

20. A computer program product for identifying misappropriators, the computer program product comprising at least one non-transitory computer-readable medium having computer-readable program code portions embodied therein, the computer-readable program code portions comprising:
an executable portion configured to identify an interaction that includes potential misappropriation;
an executable portion configured to identify a first entity and a first entity resource pool and a second entity and a second entity resource pool for the interaction;
an executable portion configured to access one or more additional first entity resource pools of the first entity and one or more additional second entity resource pools of the second entity;
an executable portion configured to identify unrelated first entity interactions of the first entity using the one or more additional first entity resource pools;
an executable portion configured to identify unrelated second entity interactions of the second entity using the one or more additional second entity resource pools;
an executable portion configured to determine that the first entity, the second entity, or an affiliated entity is a misappropriator; and
an executable portion configured to take a security action with respect to the misappropriator.
